(19) United States
(12) Patent Application Publication
(10) Pub. No.: US 2026/0128586 A1
(43) Pub. Date: May 7, 2026

(54) ON-BOARD POWER SUPPLY APPARATUS AND MANUFACTURING METHOD OF ON-BOARD POWER SUPPLY APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shinnosuke NAKAGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/104,417

(22) PCT Filed: Aug. 8, 2023
(86) PCT No.: PCT/JP2023/028880

§ 371 Date: Jan. 23, 2026

(30) Foreign Application Priority Data
Aug. 29, 2022 (JP) 2022-135853

(51) Int. Cl. H02J 3/001

(52) U.S. Cl. CPC H02J 3/001

(57) ABSTRACT

An on-board power supply apparatus includes a common path, a plurality of branch paths (first branch paths), and cutoff portions (first cutoff portions) provided on the respective branch paths (first branch paths). The branch paths (first branch paths) each include an upstream conductor (first upstream conductor) and a downstream conductor (first downstream conductor). Each cutoff portion (first cutoff portion) is provided between the upstream conductor (first upstream conductor) and the downstream conductor (first downstream conductor), and is switched from a permitted state to a cutoff state when a cutoff condition is met. The downstream conductors (first downstream conductors) are configured to be electrically connectable to each other via a conductive member. Connection portions connectable to a conductive member are provided on the respective downstream conductors (first downstream conductors).

### TECHNICAL FIELD

The present disclosure relates to an on-board power supply apparatus and a manufacturing method of an on-board power supply apparatus.

### BACKGROUND ART

Patent Document 1 discloses a power supply apparatus that supplies power of a power source to a load circuit. This power supply apparatus includes a semiconductor switch, a current detection unit, and an abnormality determination unit. The semiconductor switch is connected to a power supply line for supplying power from the power source to the load circuit. The current detection unit detects a current flowing through the power supply line. The abnormality determination unit makes determination on abnormalities based on the current detected by the current detection unit. When determining that an abnormality has occurred, the abnormality determination unit controls the semiconductor switch to restrict the current flowing through the load circuit.

### CITATION LIST

### Patent Documents

Patent Document 1: JP 2021-45023A

### SUMMARY OF INVENTION

### Technical Problem

The rated current and the number of loads mounted in a vehicle vary depending on the vehicle type and the like. In order to configure a power supply apparatus that is compatible with the various vehicle types and the like using the technique of Patent Document 1, there is a need to provide the same number of power supply lines and the same number of semiconductor switches as the number of loads for each of the rated currents of the loads, and there are concerns about an increase in the size of the power supply apparatus.

An object of the present disclosure is to provide a technique that can realize a power supply apparatus that is compatible with both a vehicle equipped with a plurality of first loads and a vehicle equipped with a second load whose rated current is larger than that of the first loads, while suppressing an increase in the size of the power supply apparatus.

### Solution to Problem

An on-board power supply apparatus according to the present disclosure includes:
a common path configured to be supplied with power based on a power source unit,
a plurality of branch paths branching from the common path, and
cutoff portions provided on the respective branch paths, and
the branch paths each include an upstream conductor and a downstream conductor provided on an opposite side to the common path side relative to the upstream conductor,
each of the cutoff portions is provided between the upstream conductor and the downstream conductor, and is switched from a permitted state where a flow of a current from the upstream conductor side to the downstream conductor side is permitted to a cutoff state where the flow of the current is cut off, when a cutoff condition is met,
the plurality of downstream conductors are configured to be electrically connectable to each other via a conductive member, and
the downstream conductors are respectively provided with connection portions that are connectable to the conductive member.

In a manufacturing method of an on-board power supply apparatus according to the present disclosure includes:
a preparing step of preparing an apparatus body that includes; a common path configured to be supplied with power based on a power source unit, a plurality of branch paths branching from the common path, and cutoff portions provided on the respective branch paths,
   the branch paths each including an upstream conductor and a downstream conductor provided on an opposite side to the common path side relative to the upstream conductor, and
   each of the cutoff portions being provided between the upstream conductor and the downstream conductor, and being switched from a permitted state where a flow of a current from the upstream conductor side to the downstream conductor side is permitted to a cutoff state where the flow of the current is cut off, when a cutoff condition is met, and
a selecting step of selecting whether or not to connect the downstream conductors on the plurality of branch paths to each other by a conductive member, and
a selection result in the selecting step is applied to the apparatus body to configure the on-board power supply apparatus.

### Advantageous Effects of Invention

A technique according to the present disclosure can realize a power supply apparatus that is compatible with both a vehicle equipped with a plurality of first loads and a vehicle equipped with a second load whose rated current is larger than that of the first loads, while suppressing an increase in the size of the power supply apparatus.

### BRIEF DESCRIPTION OF DRAWINGS

FIG. 1 is a configuration diagram schematically illustrating an on-board system that includes a power supply apparatus according to a first embodiment.

FIG. 2 is an explanatory diagram describing the power supply apparatus in a state where downstream conductors are not connected to each other by a conductive member.

FIG. 3 is an explanatory diagram describing the power supply apparatus in a state where the downstream conductors are connected to each other by the conductive member.

FIG. 4 is a configuration diagram schematically illustrating an on-board system that includes a power supply apparatus according to a second embodiment.

FIG. 5 is an explanatory diagram describing the configuration of selector switch portions and components near the selector switch portions in a power supply apparatus according to a third embodiment.

### DESCRIPTION OF EMBODIMENTS

Embodiments of the present disclosure will be listed and illustrated below.

[1] An on-board power supply apparatus includes:
a common path configured to be supplied with power based on a power source unit,
a plurality of branch paths branching from the common path, and
cutoff portions provided on the respective branch paths, and
the branch paths each include an upstream conductor and a downstream conductor provided on an opposite side to the common path side relative to the upstream conductor,
each of the cutoff portions is provided between the upstream conductor and the downstream conductor, and is switched from a permitted state where a flow of a current from the upstream conductor side to the downstream conductor side is permitted to a cutoff state where the flow of the current is cut off, when a cutoff condition is met,
the plurality of downstream conductors are configured to be electrically connectable to each other via a conductive member, and
the downstream conductors are respectively provided with connection portions that are connectable to the conductive member.

In the on-board power supply apparatus, when the plurality of downstream conductors are not connected to each other by the conductive member, the plurality of branch paths are configured as separate paths. In addition, in the on-board power supply apparatus, a path for combining, at the downstream conductors, currents having been supplied from the common path to the plurality of branch paths, is formed by the plurality of downstream conductors being connected to each other by the conductive member. That is to say, with this configuration, it is possible to realize a power supply apparatus that is compatible with both a vehicle equipped with a plurality of first loads and a vehicle equipped with a second load whose rated current is larger than that of the first loads, while suppressing an increase in the size of the power supply apparatus.

[2] The on-board power supply apparatus according to [1] further includes
a control unit configured to control the cutoff portions,
the control unit is capable of selectively executing first control and second control,
the first control is control for determining whether or not an individual cutoff condition that is the cutoff condition is met, for each of the branch paths based on a value of a current flowing through the branch path, and switching, to the cutoff state, the cutoff portion provided on the branch path for which it is determined that the individual cutoff condition is met, and
the second control is control for determining whether or not a collective cutoff condition that is the cutoff condition is met, based on a value of a current flowing through at least one of the branch paths, and switching the cutoff portions provided on the plurality of branch paths, to the cutoff state if it is determined that the collective cutoff condition is met.

The first control is control that envisions a configuration in which the plurality of downstream conductors are not electrically connected to each other by the conductive member, and enables a branch path for which the individual cutoff condition is met to be individually disconnected. The second control is control that envisions a configuration in which the plurality of downstream conductors are electrically connected to each other by the conductive member, and enables the plurality of branch paths to be collectively disconnected when an abnormality occurs. That is to say, the on-board power supply apparatus can selectively execute control for both the configuration in which the plurality of downstream conductors are electrically connected to each other by the conductive member and the configuration in which they are not.

[3] In the on-board power supply apparatus according to [2],
when a signal instructing which of the first control and the second control is to be executed is given from outside, the control unit executes the control instructed by the signal.

With this configuration, by giving a signal to the control unit from outside, it is possible to instruct the control unit to perform control that is to be executed by the control unit.

[4] The on-board power supply apparatus according to [2], further includes
a determination unit configured to determine whether or not the plurality of downstream conductors are in a conductive state of being electrically connected to each other by the conductive member, and
the control unit executes the first control if the determination unit determines that the plurality of downstream conductors are not in the conductive state, and executes the second control if the determination unit determines that the plurality of downstream conductors are in the conductive state.

The on-board power supply apparatus can automatically select and execute appropriate control in accordance with whether or not the plurality of downstream conductors are in the conductive state.

[5] In the on-board power supply apparatus according to [4],
on each of the branch paths, a switch portion is provided between the upstream conductor and the downstream conductor,
when a determination start condition is met, then, in a state where control is performed so as to bring, into an on-state, the switch portions provided on some branch paths among the plurality of branch paths, and control is performed so as to bring the switch portion provided on another branch path into an off-state, the determination unit obtains a value of a current flowing through at least one branch path among the branch paths in the on state, and determines whether or not the downstream conductors are in the conductive state based on the obtained value of the current.

The on-board power supply apparatus can determine whether or not the downstream conductors are in the conductive state, with a simple configuration.

[6] In the on-board power supply apparatus according to [2] to [5],
the individual cutoff condition is a condition that is met when the value of the current flowing through the branch path exceeds a first threshold value, and
the collective cutoff condition is a condition that is met when a value obtained by multiplying a value of a current flowing through one branch path by a predetermined multiplier exceeds a second threshold value that is larger than the first threshold value.

The on-board power supply apparatus can determine whether or not the collective cutoff condition is met, based on the value of the current flowing through the one branch path.

[7] In the on-board power supply apparatus according to any one of [1] to [6],
at least one electronic component that includes the cutoff portion is provided between the upstream conductor and the downstream conductor,
a load-side connection portion for connection to a load is provided on the downstream conductor, and
the connection portion is disposed between the at least one electronic component and the load-side connection portion, closer to the load-side connection portion side.

The on-board power supply apparatus can keep currents combined via the conductive member from flowing through the electronic component provided between the upstream conductor and the downstream conductor.

[8] In the on-board power supply apparatus according to any one of [1] to [7],
the plurality of downstream conductors include two parallel downstream conductors aligned parallel to each other,
the connection portion is provided on a surface on one side in an orthogonal direction of each of the parallel downstream conductors, the orthogonal direction being a direction that is orthogonal to a direction in which the two parallel downstream conductors extend and is orthogonal to a direction in which the two parallel downstream conductors are aligned, and
the connection portions provided on the respective parallel downstream conductors face each other in the direction in which the two parallel downstream conductors are aligned.

In the on-board power supply apparatus, each of the connection portions of the parallel downstream conductors is provided on a surface on one side in the orthogonal direction, and thus the conductive member is easily connected. Moreover, the connection portions face each other in the direction in which the two parallel downstream conductors are aligned, and thus it is easy to shorten the length of the conductive member.

[9] In the on-board power supply apparatus according to any one of [1] to [8],
the cutoff portions provided on the respective branch paths are formed by elements of the same model number.

In the on-board power supply apparatus, it is easy to ensure the uniformity of cutoff performance of the cutoff portions provided on the respective branch paths.

[10] A manufacturing method of an on-board power supply apparatus includes:
a preparing step of preparing an apparatus body that includes: a common path configured to be supplied with power based on a power source unit, a plurality of branch paths branching from the common path, and cutoff portions provided on the respective branch paths,
   the branch paths each including an upstream conductor and a downstream conductor provided on an opposite side to the common path side relative to the upstream conductor, and
   each of the cutoff portions being provided between the upstream conductor and the downstream conductor, and being switched from a permitted state where a flow of a current from the upstream conductor side to the downstream conductor side is permitted to a cutoff state where the flow of the current is cut off, when a cutoff condition is met, and
a selecting step of selecting whether or not to connect the downstream conductors on the plurality of branch paths to each other by a conductive member, and
a selection result in the selecting step is applied to the apparatus body to configure the on-board power supply apparatus.

If, in the selecting step, not connecting the plurality of downstream conductors to each other using the conductive member is selected, the plurality of branch paths can be configured as separate paths. In addition, if, in the selecting step, connecting the plurality of downstream conductors to each other using the conductive member is selected, it is possible to configure a path for combining, at the downstream conductors, currents having been supplied from the common path to the plurality of branch paths. That is to say, with this configuration, it is possible to realize a power supply apparatus that is compatible with both a vehicle equipped with a plurality of first loads and a vehicle equipped with a second load whose rated current is larger than that of the first loads while suppressing an increase in the size of the power supply apparatus.

### First Embodiment

### 1. Configuration of On-Board Power Supply Apparatus 10

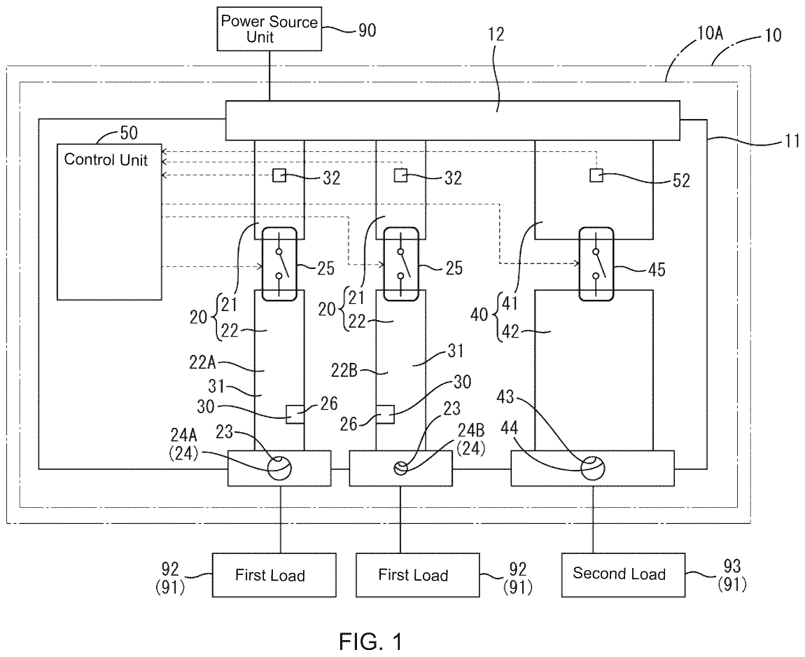

An on-board power supply apparatus 10 (hereinafter, also simply referred to as a “power supply apparatus 10”) shown in FIG. 1 is attached to a vehicle (not illustrated). A power source unit 90 is mounted in the vehicle. The power source unit 90 is a DC power source such as a battery. The negative electrode of the battery is electrically connected to the ground.

It is envisioned that the power supply apparatus 10 is attached to a plurality of types of vehicles among which the rated current of a load differs. The plurality of types of vehicles refers to vehicles among which the rated current of at least one load differs due to a vehicle type, grade, shipping destination, option, and the like.

The power supply apparatus 10 is configured as a junction box, an electrical connection box, or the like. The power supply apparatus 10 includes a case 11, a common path 12, a first branch path 20, and a second branch path 40.

The common path 12 is formed by a bus bar, for example, and is shaped as a plate. At least a portion of the common path 12 is disposed in the case 11. The common path 12 is electrically connected to the power source unit 90 (more specifically, the positive electrode of the battery). The common path 12 is supplied with power based on the power source unit 90.

The first branch path 20 is a path branching from the common path 12. The first branch path 20 is designed for a current of 10 A flows. A plurality of (in the present embodiment, two) first branch paths 20 are provided. The plurality of first branch paths 20 are disposed parallel to each other. The first branch paths 20 each include a first upstream conductor 21 and a first downstream conductor 22.

The first upstream conductor 21 is electrically connected to the common path 12 in a state of being short-circuited to the common path 12. The first upstream conductor 21 is formed by a bus bar, for example, and is shaped as a plate. One end side of the first upstream conductor 21 is fixed to the common path 12. The fixing method is not particularly limited, and may adopt soldering, welding, or fastening with a bolt, for example.

The first downstream conductor 22 is provided on the opposite side to (downstream of) the common path 12 relative to the first upstream conductor 21. The first downstream conductor 22 is formed by a bus bar, for example, and is shaped as a plate. The first downstream conductor 22 has a shape elongated along the direction in which a current flows. A first load-side connection portion 23 for connection to the load 91 is provided on the first downstream conductor 22. In the present embodiment, a configuration will be described in which a first insertion hole 24 for inserting a bolt (for example, a stud bolt) is formed in the first load-side connection portion 23, but another configuration may be adopted. A configuration may also be adopted in which, for example, a mounting surface for surface-mounting a wiring portion on the load 91 side is formed in the first load-side connection portion 23. The first load-side connection portion 23 is electrically connected to the load 91 using a bolt. The bolt that is inserted into the first insertion hole 24 of the first load-side connection portion 23 functions as a portion of a power supply path to the load 91. One of the plurality of first insertion holes 24 (more specifically, a first insertion hole 24A) has an internal diameter suitable for 20 A or smaller, and the other first insertion hole 24 (more specifically, a first insertion hole 24B) has an internal diameter suitable for 10 A or smaller. For this reason, the internal diameter of the one first insertion hole 24 (more specifically, the first insertion hole 24A) is larger than the internal diameter of the other first insertion hole 24 (more specifically, the first insertion hole 24B).

The loads 91 include first loads 92 and a second load 93 whose rated current is larger than that of the first loads 92. The rated current of the first loads 92 is 10 A, for example, and the rated current of the second load 93 is 20 A, for example. That is to say, the rated current of the second load 93 is an integer multiple of (more specifically, twice) the rated current of the first loads 92. The first loads 92 are heaters designed for regions other than cold regions or chillers, for example. The second load 93 is a heater for cold regions, for example.

The power supply apparatus 10 includes a plurality of first cutoff portions 25. The first cutoff portions 25 are provided on the respective first branch paths 20. Each of the first cutoff portions 25 is provided between the first upstream conductor 21 and the first downstream conductor 22, and is switched from a first permitted state where a flow of a current from the first upstream conductor 21 side to the first downstream conductor 22 side is permitted to a first cutoff state where the flow of the current is cut off, when a cutoff condition is met. The first cutoff portions 25 provided on the respective first branch paths 20 are formed by elements of the same model number. With this configuration, the power supply apparatus 10 easily uniformize the cutoff performance of the first cutoff portions 25 on the first branch paths 20. In the present embodiment, the first cutoff portions 25 each have a configuration that includes a switching element, more specifically, a configuration that includes a semiconductor switching element. The configuration that includes a semiconductor switching element may be a configuration that includes only a semiconductor switching element, or may be a configuration that includes a protection circuit or the like (for example, IPD (Intelligent Power Device)). The semiconductor switching element may be a MOSFET (Metal-Oxide-Semiconductor Field Effect Transistor), for example. The first cutoff portion 25 is joined to the first upstream conductor 21 and the first downstream conductor 22. The first cutoff portion 25 also function as a switch portion. When the semiconductor switching element is in an on-state, the first cutoff portion 25 is in the permitted state, and electrically connects the first upstream conductor 21 and the first downstream conductor 22. When the semiconductor switching element is in an off-state, the first cutoff portion 25 is in the cutoff state, and disconnects the first upstream conductor 21 and the first downstream conductor 22. That is to say, the first cutoff portion 25 is switched between the permitted state and the cutoff state.

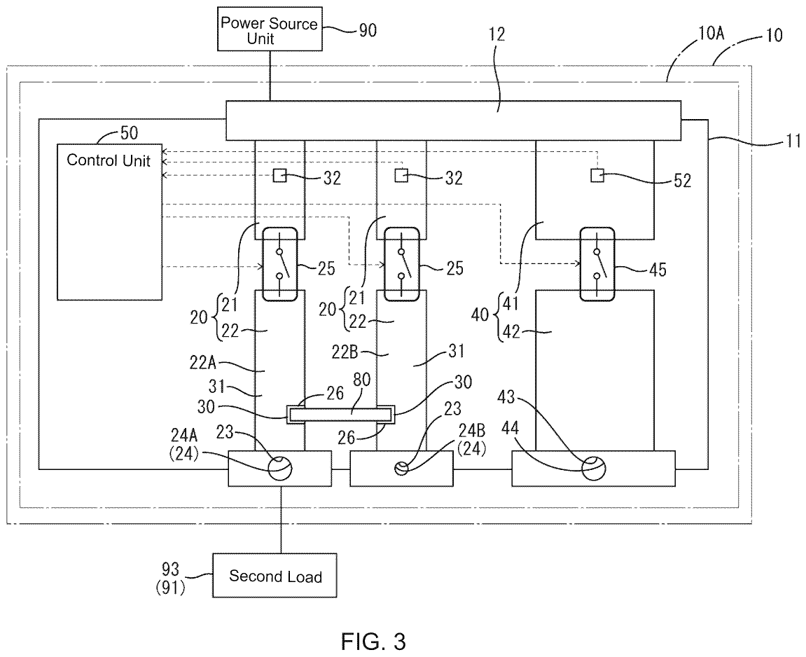

A configuration is adopted in which the plurality of first downstream conductors 22 can be electrically connected to each other via a conductive member 80 (see FIG. 3). Connection portions 26 connectable to the conductive member 80 are provided on the respective first downstream conductors 22. The bus bars that form the first downstream conductors 22 each include a conductive base material 30 and an insulation layer 31 that covers a portion of the base material. The connection portions 26 are each formed by an exposed surface of the base material 30 that is exposed without being covered by the insulation layer 31. The connection portions 26 are each disposed on the first load-side connection portion 23 side between the first cutoff portion 25 and the first load-side connection portion 23. With this configuration, the power supply apparatus 10 can keep currents combined via the conductive member 80 from flowing to the first cutoff portion 25 provided between the first upstream conductor 21 and the first downstream conductor 22.

The plurality of first downstream conductors 22 include two parallel downstream conductors 22A and 22B aligned parallel to each other. The two parallel downstream conductors 22A and 22B are aligned in a direction orthogonal to the thickness direction thereof. Each of the connection portions 26 is provided on the surface on one side in an orthogonal direction of the parallel downstream conductor 22A or 22B, the orthogonal direction being a direction that is orthogonal to the direction in which the parallel downstream conductors 22A and 22B extend and is orthogonal to the direction in which the parallel downstream conductors 22A and 22B are aligned (the thickness direction of the first downstream conductors 22). The connection portions 26 provided on the parallel downstream conductors 22A and 22B face each other in the direction in which the parallel downstream conductors 22A and 22B are aligned. That is to say, the connection portion 26 on the parallel downstream conductor 22A on one side in the direction in which the parallel downstream conductors 22A and 22B are aligned is disposed on the other side of the parallel downstream conductor 22A, and the connection portion 26 on the parallel downstream conductor 22B on the other side is disposed on the one side of the parallel downstream conductor 22B. In this power supply apparatus 10, each of the connection portions 26 of the parallel downstream conductors 22A and 22B is provided on the surface on one side in the above orthogonal direction of the parallel downstream conductor 22A or 22B, and thus the conductive member 80 is easily connected. Moreover, the connection portions 26 face each other in the direction in which the parallel downstream conductors 22A and 22B are aligned. For this reason, in the power supply apparatus 10, it is easy to shorten the length of the conductive member 80.

Furthermore, the connection portion 26 provided on the parallel downstream conductor 22A on the one side is provided in an end portion on the other side of the parallel downstream conductor 22A. The connection portion 26 provided on the parallel downstream conductor 22B on the other side is provided in an end portion on the one side of the parallel downstream conductor 22B. For this reason, in the power supply apparatus 10, it is easy to further shorten the length of the conductive member 80.

The conductive member 80 is conductive, and is shaped as a bar, for example. The conductive member 80 is connected to the connection portions 26 of the plurality of first downstream conductors 22, and spans the plurality of first downstream conductors 22. The conductive member 80 electrically connects the plurality of first downstream conductors 22 to each other. The conductive member 80 short-circuits the first downstream conductors 22 to each other.

In the power supply apparatus 10, the plurality of first branch paths 20 are configured as separate paths when the plurality of first branch paths 20 are not connected to each other by the conductive member 80. Also, in the power supply apparatus 10, a path for combining, at the first downstream conductors 22, currents having been supplied from the common path 12 to the plurality of first branch paths 20, is configured by the plurality of first branch paths 20 being connected by the conductive member 80. That is to say, with this configuration, it is possible to realize the power supply apparatus 10 that is compatible with both a vehicle equipped with the plurality of first loads 92 and a vehicle equipped with the second load 93 whose rated current is larger than that of the first loads 92, while suppressing an increase in the size of the power supply apparatus 10.

The power supply apparatus 10 includes a plurality of first current detection units 32. The first current detection units 32 are provided on the respective first branch paths 20, and detect the values of currents flowing through the first branch paths 20. The first current detection units 32 are provided on the common path 12 side (more specifically, on the first upstream conductors 21) relative to the connection portions 26 on the first branch paths 20, and detect the values of currents flowing on the common path 12 side (more specifically, through the first upstream conductors 21) relative to the connection portions 26 on the first branch paths 20. Each of the first current detection units 32 outputs a signal with which the value of a current flowing through the first branch path 20 can be specified. The first current detection unit 32 includes a known current sensor (in the present embodiment, a hall element), for example.

The second branch path 40 is a path branching from the common path 12. The second branch path 40 includes a second upstream conductor 41 and a second downstream conductor 42. The second branch path 40 is a path through which a larger current than those on the first branch paths 20 can flow. In the present embodiment, the second branch path 40 is designed for a current of 20 A flows.

The second upstream conductor 41 is electrically connected to the common path 12 in the form of being short circuited to the common path 12. The second upstream conductor 41 is formed by a bus bar, for example, and is shaped as a bar. One end side of the second upstream conductor 41 is fixed to the common path 12. The fixing method is not particularly limited, and may adopt soldering, welding, or fastening with a bolt, for example. The above first upstream conductors 21 have a smaller cross-section (cross-section cut along a direction orthogonal to the direction in which a current flows) than the second upstream conductor 41.

The second downstream conductor 42 is provided on the opposite side to (downstream of) the common path 12 side relative to the second upstream conductor 41. The second downstream conductor 42 is formed by a bus bar, for example, and is shaped as a plate. The second downstream conductor 42 has a shape elongated along the direction in which a current flows. A second load-side connection portion 43 for connection to a load 91 (more specifically, the second load 93) is provided on the second downstream conductor 42. In the present embodiment, a configuration will be described in which a second insertion hole 44 for inserting a bolt (for example, a stud bolt) is formed in the second load-side connection portion 43, but another configuration may be adopted. A configuration may also be adopted in which, for example, a mounting surface for surface-mounting a wire portion on the load 91 side is formed in the second load-side connection portion 43. The second load-side connection portion 43 is electrically connected to the load 91 using a bolt. The bolt that is inserted into the second insertion hole 44 of the second load-side connection portion 43 functions as a portion of a power supply path to the load 91. The second insertion hole 44 has an internal diameter suitable for a current of 20 A or smaller. That is to say, the internal diameter of the second insertion hole 44 is the same as the internal diameter of each first insertion hole 24A. Note that “the same internal diameter” is not limited to exactly the same internal diameter, and also includes substantially the same internal diameter. “Substantially the same internal diameter” indicates that the percentage of the difference between the internal diameter of the second insertion hole 44 and the internal diameter of the first insertion hole 24A to the larger internal diameter of the two being 5% or smaller.

The power supply apparatus 10 includes a second cutoff portion 45. The second cutoff portion 45 is provided on the second branch path 40. The second cutoff portion 45 is provided between the second upstream conductor 41 and the second downstream conductor 42, and is switched from a second permitted state where a current is permitted to flow from the second upstream conductor 41 side to the second downstream conductor 42 side to a second cutoff state where the flow of the current is cut off, when a second cutoff condition is met. In the present embodiment, the second cutoff portion 45 has a configuration that includes a switching element, more specifically, a configuration that includes a semiconductor switching element. The “configuration that includes a semiconductor switching element” may be a configuration that includes only a semiconductor switching element, or a configuration that includes a protection circuit or the like (for example, IPD (Intelligent Power Device)). The semiconductor switching element may be a MOSFET (Metal-Oxide-Semiconductor Field Effect Transistor), for example. The second cutoff portion 45 is joined to the second upstream conductor 41 and the second downstream conductor 42. The second cutoff portion 45 also functions as a second switch portion. When the semiconductor switching element is in an on-state, the second cutoff portion 45 is in the second permitted state, and electrically connects the second upstream conductor 41 and the second downstream conductor 42 to each other. When the semiconductor switching element is in an off-state, the second cutoff portion 45 is in the second cutoff state, and disconnects the second upstream conductor 41 and the second downstream conductor 42. That is to say, the second cutoff portion 45 is switched between the second permitted state and the second cutoff state.

The power supply apparatus 10 includes a second current detection unit 52. The second current detection unit 52 is provided on the second branch path 40, and detects the value of a current flowing through the second branch path 40. The second current detection unit 52 outputs a signal with which the value of a current flowing through the second branch path 40 can be specified. The second current detection unit 52 includes a known current sensor (in the present embodiment, a hall element), for example.

The power supply apparatus 10 includes a control unit 50 that controls the first cutoff portions 25 and the second cutoff portion 45. The control unit 50 includes an MCU (Micro Controller Unit), a drive circuit for switching elements, and the like. The control unit 50 receives signals output from the first current detection units 32, and obtains the values of currents flowing through the first branch paths 20. The control unit 50 receives a signal output from the second current detection unit 52, and obtains the value of a current flowing through the second branch path 40.

The control unit 50 can selectively execute first control and second control. The first control is control that envisions a configuration in which the plurality of first downstream conductors 22 are not electrically connected to each other by the conductive member 80. The first control is control for determining whether or not an individual cutoff condition, that is one of first cutoff conditions, is met for each of the first branch paths 20 based on the value of a current flowing through the first branch path 20, and switches, to the first cutoff state, the first cutoff portion 25 provided on the first branch path 20 for which it is determined that the individual cutoff condition is met.

The second control is control that envisions a configuration in which the plurality of first downstream conductors 22 are electrically connected to each other by the conductive member 80. The second control is control for determining whether or not an collective cutoff condition, which is one of the first cutoff conditions, is met, based on the value of a current flowing through at least one of the first branch paths 20, and switching the first cutoff portions 25 provided on the respective first branch paths 20 to the first cutoff state if it is determined that the collective cutoff condition is met. With this configuration, the power supply apparatus 10 can selectively execute control for both the configuration in which the plurality of first downstream conductors 22 are electrically connected to each other by the conductive member 80 and the configuration in which they are not.

When a signal instructing which of the first control and the second control is to be executed is given from outside, the control unit 50 executes the control instructed by the signal. With this configuration, by giving a signal to the control unit 50 from outside, it is possible to instruct the control unit 50 to perform control that is to be executed by the control unit 50. The instruction from outside is basically given before the power supply apparatus 10 is mounted in a vehicle.

The control unit 50 determines whether or not the second cutoff condition is met, based on the value of a current flowing through the second branch path 40, and switches, to the second cutoff state, the second cutoff portion 45 provided on the second branch path 40 for which it is determined that the second cutoff condition is met.

The individual cutoff condition is a condition that is met when the value of a current flowing through the first branch path 20 exceeds a first threshold value. The individual cutoff condition may be a condition that is immediately met when the value of a current flowing through the first branch path 20 exceeds the first threshold value, or may also be a condition that is met when the value of a current flowing through the first branch path 20 continues to exceed the first threshold value for a first predetermined time. The first predetermined time may change in accordance with the degree to which the value of a current flowing through the first branch path 20 exceeds the first threshold value. The larger the degree to which the value of a current flowing through the first branch path 20 exceeds the first threshold value is, the shorter the first predetermined time may become, for example. The individual cutoff condition may also be a condition that is met based on first correspondence data indicating the correspondence relationship between each of a plurality of current values and a first predetermined time corresponding to the current value, and the value of a current flowing through the first branch path 20. Each time a current value indicated by the first correspondence data is exceeded, for example, the control unit 50 may start determination on whether or not the first predetermined time corresponding to the current value has elapsed, and switch the first cutoff portion 25 to the first cutoff state if it is determined that the first predetermined time has elapsed. The first correspondence data may be functional data or table data.

The collective cutoff condition is a condition that is met when a value obtained by multiplying the value of a current flowing through one of the first branch paths 20 by a predetermined multiplier (in the present embodiment, 2) exceeds a second threshold value that is larger than the first threshold value. With this configuration, the power supply apparatus 10 can determine whether or not the collective cutoff condition is met, based on the value of a current flowing through the one first branch path 20. The multiplier takes a value larger than 1. The multiplier is the number of first branch paths 20, more specifically, the number of first branch paths 20 that can be electrically connected via the conductive member 80. The collective cutoff condition may be a condition that is immediately met when the value obtained by multiplying the value of a current flowing through one of the first branch paths 20 by the predetermined multiplier exceeds the second threshold value, or may also be a condition that is met when the second threshold value continues to be exceeded for a second predetermined time. The second predetermined time may change in accordance with the degree to which the value obtained by multiplying the value of a current flowing through one of the first branch paths 20 by the predetermined multiplier exceeds the second threshold value. The larger the degree to which the value obtained by multiplying the value of a current flowing through one of the first branch paths 20 by the predetermined multiplier exceeds the second threshold value is, the shorter the second predetermined time may become, for example. The collective individual cutoff condition may also be a condition that is met based on second correspondence data indicating the correspondence relationship between each of a plurality of current values and a second predetermined time corresponding to the current value, and the value obtained by multiplying the value of a current flowing through one of the first branch paths 20 by the predetermined multiplier. Each time a current value indicated by the second correspondence data is exceeded, the control unit 50 may start determination on whether or not a second predetermined time corresponding to the current value has elapsed, and switch the first cutoff portions 25 to the first cutoff state if it is determined that the second predetermined time has elapsed. The first correspondence data may be functional data or table data.

The second cutoff condition is a condition that is met when the value of a current flowing through the second branch path 40 exceeds the second threshold value. The second cutoff condition may be a condition that is immediately met when the value of a current flowing through the second branch path 40 exceeds the second threshold value, or may also be a condition that is met when the value of a current flowing through the second branch path 40 continues to exceed the second threshold value for a second predetermined time. The second predetermined time may change in accordance with the degree to which the value of a current flowing through the second branch path 40 exceeds the second threshold value. The larger the degree to which the value of a current flowing through the second branch path 40 exceeds the second threshold value is, the shorter the second predetermined time may become, for example. The second cutoff condition may also be a condition that is met based on the above second correspondence data and the value of a current flowing through the second branch path 40. Each time a current value indicated by the second correspondence data is exceeded, for example, the control unit 50 may start determination on whether or not the second predetermined time corresponding to the current value has elapsed, and switch the second cutoff portion 45 to the second cutoff state if it is determined that the second predetermined time has elapsed.

With this configuration, in the power supply apparatus 10, the second threshold value can be used for both the collective cutoff condition and the second cutoff condition. In addition, in the power supply apparatus 10, the second correspondence data can be used for both the collective cutoff condition and the second cutoff condition.

### 2. Operations of Power Supply Apparatus 10

The control unit 50 of the power supply apparatus 10 performs control instructed from outside the power supply apparatus 10, of the first control and the second control.

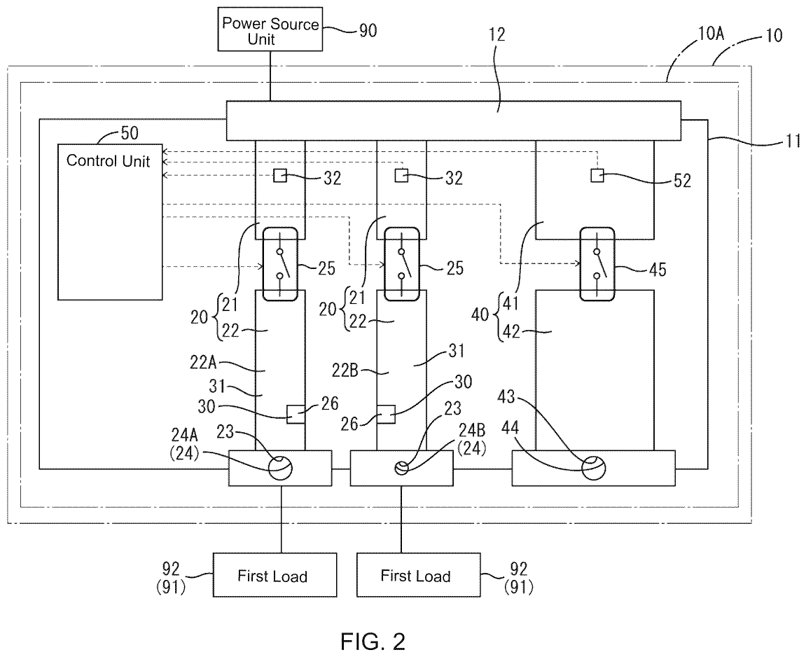

When an instruction to perform the first control is given, the control unit 50 operates as follows. Note that it is envisioned that the power supply apparatus 10 has a configuration in which the first loads 92 are respectively connected to the first branch paths 20 and no load 91 is connected to the second branch path 40, as shown in FIG. 2. When a start condition is met, the control unit 50 starts monitoring the values of currents flowing through the respective first branch paths 20. The start condition is, for example, an activation switch (for example, an ignition switch, a power switch, or the like) of the vehicle having been switched from an off-state to an on-state. In this case, when a permission condition is met for one of the first branch paths 20, the control unit 50 switches, to the first permitted state, the first cutoff portion 25 provided on the first branch path 20 for which the permission condition is met, and supplies power to the first load 92. The permission condition is, for example, a permission operation having been performed by the user. Note that the second cutoff portion 45 is kept in the second cutoff state. The control unit 50 determines whether or not the individual cutoff condition is met for each of the first branch paths 20 based on the value of a current flowing through the first branch path 20. If it is determined that the individual cutoff condition is not met for any of the first branch paths 20, the control unit 50 repeats determination on whether or not the individual cutoff condition is met for each of the first branch paths 20 based on the value of a current flowing through the first branch path 20. If it is determined that the individual cutoff condition is met, the control unit 50 switches, to the first cutoff state. the first cutoff portion 25 provided on the first branch path 20 for which it is determined that the individual cutoff condition is met.

When an instruction to perform the second control is given, the control unit 50 operates as follows. Note that it is envisioned that the power supply apparatus 10 has a configuration in which the second load 93 is connected to one of the first branch paths 20 and no load 91 is connected to the other first branch path 20 and the second branch path 40, as shown in FIG. 3. When the above start condition is met, the control unit 50 starts monitoring the value of a current flowing through one of the first branch paths 20. When a permission condition is met for the first branch paths 20, the control unit 50 switches the first cutoff portions 25 provided on the respective first branch paths 20 to the first permitted state, and supplies power to the second load 93. Note that the second cutoff portion 45 is kept in the second cutoff state. The control unit 50 determines whether or not the collective cutoff condition is met, based on the value of a current flowing through one of the first branch paths 20. If it is determined that the collective cutoff condition is not met, the control unit 50 repeats determination on whether or not the collective cutoff condition is met, based on the value of a current flowing through one of the first branch paths 20. If it is determined that the collective cutoff condition is met, the control unit 50 switches the first cutoff portions 25 provided on the first branch paths 20 to the first cutoff state.

Note that, in a configuration in which the second load 93 is connected to the second branch path 40, the control unit 50 further starts monitoring the value of a current flowing through the second branch path 40. The control unit 50 then determines whether or not the second cutoff condition is met, based on the value of a current flowing through the second branch path 40. If it is determined that the second cutoff condition is not met, the control unit 50 repeats determination on whether or not the second cutoff condition is met, based on the value of a current flowing through the second branch path 40. If it is determined that the second cutoff condition is met, the control unit 50 switches the second cutoff portion 45 provided on the second branch path 40 to the second cutoff state.

### 3. Manufacturing Method of Power Supply Apparatus 10

A manufacturing method of the power supply apparatus 10 includes a preparing step and a selecting step.

In the preparing step, an apparatus body 10A is prepared. The apparatus body 10A includes the common path 12 that is supplied with power based on the power source unit 90, the plurality of first branch paths 20 branching from the common path 12, and the first cutoff portions 25 provided on the respective first branch paths 20. The first branch paths 20 each include the first upstream conductor 21 and the first downstream conductor 22 provided on the opposite side to the common path 12 side relative to the first upstream conductor 21. Each of the first cutoff portions 25 is provided between the first upstream conductor 21 and the first downstream conductor 22, and is switched from the first permitted state where a flow of a current from the first upstream conductor 21 side to the first downstream conductor 22 side is permitted to the first cutoff state where the flow of the current is cut off, when the first cutoff condition is met.

In the selecting step, it is selected whether or not to connect the first downstream conductors 22 on the plurality of first branch paths 20 using the conductive member 80. The selection result obtained in the selecting step is then applied to the apparatus body 10A to configure the power supply apparatus 10.

If, in the selecting step, not connecting the plurality of first downstream conductors 22 using the conductive member 80 is selected, the plurality of first branch paths 20 can be configured as separate paths. If, in the selecting step, connecting the plurality of first downstream conductors 22 using the conductive member 80 is selected, it is possible to configure a path for combining, at the first downstream conductors 22, currents having been supplied from the common path 12 to the plurality of first branch paths 20. That is to say, with this configuration, it is possible to realize the power supply apparatus 10 that is compatible with both a vehicle equipped with the plurality of first loads 92 and a vehicle equipped with the second load 93 whose rated current is larger than that of the first loads 92, while suppressing an increase in the size of the power supply apparatus 10.

### Second Embodiment

The on-board power supply apparatus 10 according to the first embodiment has a configuration in which either the first control or the second control is selected and executed in accordance with an instruction from outside. In contrast, in the second embodiment, a configuration will be described in which an on-board power supply apparatus 210 itself determines which control is to be executed. Note that, in the description of the second embodiment, the same constituent elements as the first embodiment are given the same reference numerals, and a detailed description thereof is omitted.

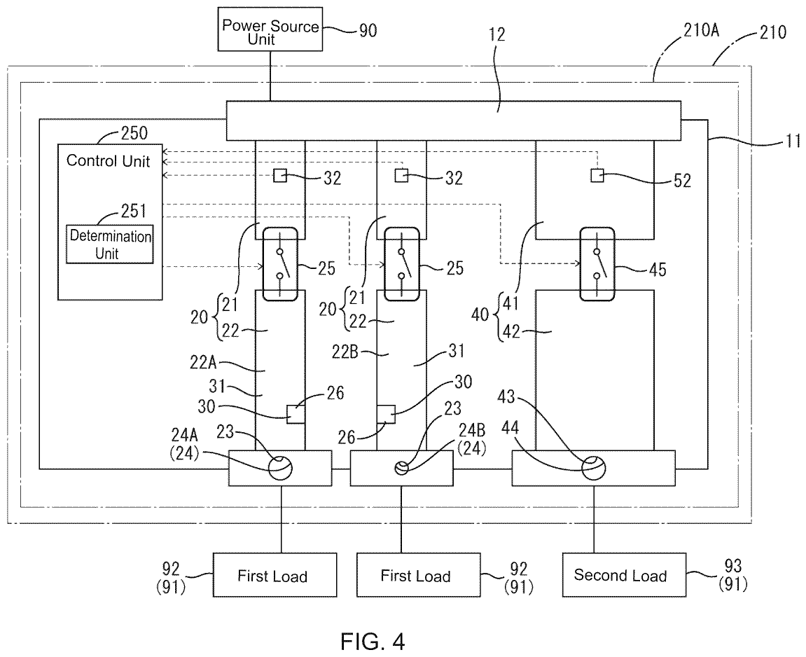

The on-board power supply apparatus 210 (hereinafter, also simply referred to as a “power supply apparatus 210”) according to the second embodiment is different from the power supply apparatus 10 according to the first embodiment, mainly in that a control unit 250 is provided as shown in FIG. 4. An apparatus body 210A shown in FIG. 4 is different from the apparatus body 10A according to the first embodiment, mainly in that the control unit 250 is included. The control unit 250 is different from the control unit 50 according to the first embodiment, mainly in that a determination unit 251 is included.

The determination unit 251 determines whether or not the plurality of first downstream conductors 22 are in a conductive state of being electrically connected by the conductive member 80 (see FIG. 3). More specifically, when a determination start condition is met, then, in a state where control is performed so as to bring the first cutoff portions 25 provided on some first branch paths 20 among the plurality of first branch paths 20 into the first permitted state, and control is performed so as to bring the first cutoff portion 25 provided on another first branch path 20 into the first cutoff state (that is to say, in a state where control is performed so as to bring the switch portions provided on some of the first branch paths 20 into an on-state, and control is performed so as to bring the switch portion provided on another first branch path 20 to an off-state), the determination unit 251 obtains the value of a current flowing through at least one of the first branch paths 20 in the first permitted state, and determines whether or not the plurality of first downstream conductors 22 are in the conductive state, based on the obtained value of the current.

In the present embodiment, when the determination start condition is met, then, in a state where control is performed so as to bring the first cutoff portion 25 provided on one of the two first branch paths 20 into the first permitted state, and control is performed so as to bring the first cutoff portion 25 provided on the other first branch path 20 into the first cutoff state (that is to say, in a state where control is performed so as to bring the switch portion provided on one of the first branch paths 20 into the on state, and control is performed so as to bring the switch portion provided on the other first branch path 20 into the off-state), the value of a current flowing through the one first branch path 20 is obtained, and determination is performed on whether or not the plurality of first downstream conductors 22 are in the conductive state, based on the obtained current value. With this configuration, the power supply apparatus 210 can determine whether or not the plurality of first downstream conductors 22 are in the conductive state, with a simple configuration.

The determination unit 251 determines whether or not the obtained current value has exceeded a determination threshold value (for example, 15 A), and determines that the plurality of first downstream conductors 22 are not in the conductive state if it is determined that the determination threshold value is not exceeded, and determines that the plurality of first downstream conductors 22 are in the conductive state if it is determined that the determination threshold value is exceeded, for example.

Note that the determination start condition may be, for example, that the control unit 250 is started for the first time after the power supply apparatus 210 is mounted in a vehicle, or that the activation switch of the vehicle is switched to the on-state.

The control unit 250 selects and executes the first control if the determination unit 251 determines that the plurality of first downstream conductors 22 are not in the conductive state, and selects and executes the second control if the determination unit 251 determines that the plurality of first downstream conductors 22 are in the conductive state.

With this configuration, the power supply apparatus 210 can automatically select and execute suitable control in accordance with whether or not the plurality of first downstream conductors 22 are in the conductive state.

### Third Embodiment

In the first embodiment, a configuration is adopted in which each of the first cutoff portions 25 is individually controlled in the second control. In contrast, in a third embodiment, a configuration will be described in which the first cutoff portions 25 are collectively controlled in the second control. Note that, in the description of the third embodiment, the same constituent elements as the first embodiment are given the same reference numerals, and a detailed description thereof is omitted.

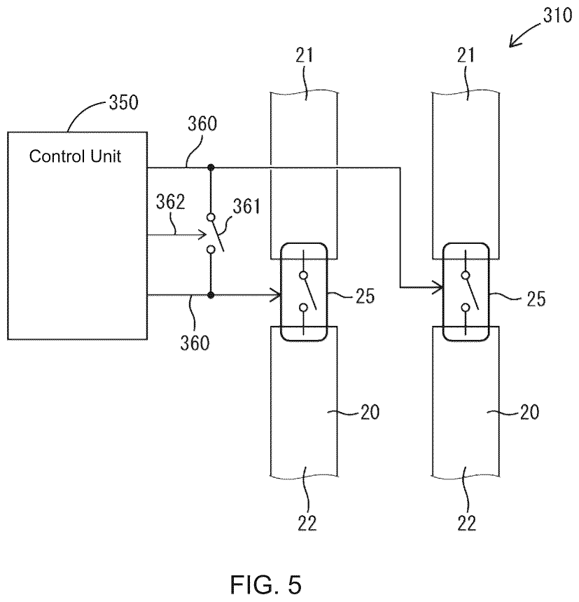

As shown in FIG. 5, an on-board power supply apparatus 310 (hereinafter, also simply referred to as a “power supply apparatus 310”) according to the third embodiment includes first signal lines 360, a selector switch portion 361, a second signal line 362, and a control unit 350.

The first signal lines 360 are provided in correspondence with the first cutoff portions 25. The first signal lines 360 provide a control signal (for example, an on-off signal) output from the control unit 350 to the respective first cutoff portions 25.

The selector switch portion 361 is provided between the first signal lines 360, electrically connects the first signal lines 360 to each other in an on-state, and disconnects the first signal lines 360 from each other in an off-state. The selector switch portion 361 has a configuration that includes a switching element, more specifically, a configuration that includes a semiconductor switching element. The “configuration that includes a semiconductor switching element” may be a configuration that includes only a semiconductor switching element, or may be a configuration that includes a protection circuit or the like (for example, IPD (Intelligent Power Device)). The semiconductor switching element may be a MOSFET (Metal-Oxide-Semiconductor Field Effect Transistor), for example.

The second signal line 362 provides a control signal (for example, an on-off signal) output from the control unit 350, to the selector switch portion 361.

The control unit 350 is different from the control unit 50 according to the first embodiment mainly in that the control unit 350 controls the selector switch portion 361. The control unit 350 provides a control signal to the first cutoff portions 25 via the first signal lines 360. The control unit 350 can control the selector switch portion 361 by providing a control signal to the selector switch portion 361 via the second signal line 362.

In the first control described in the first embodiment, the control unit 350 performs control so as to bring the selector switch portion 361 into the off-state. When the selector switch portion 361 is in the off-state, the control unit 350 can individually control the first cutoff portions 25 (switch portions) via the respective first signal lines 360. In addition, in the second control described in the first embodiment, the control unit 350 performs control so as to bring the selector switch portion 361 into the on-state. When the selector switch portion 361 is in the on-state, the control unit 350 can collectively control the plurality of first cutoff portions 25 (switch portions) via one of the first signal lines 360. That is to say, by outputting a control signal to one of the plurality of first signal lines 360, the control unit 350 can collectively provide the control signal to the plurality of first cutoff portions 25 (switch portions), and collectively control the plurality of first cutoff portions 25 (switch portions).

### Other Embodiments

The present disclosure is not limited to the embodiments described above with reference to the drawings. Any combination of characteristics in the embodiments described above and below can be made as long as no contradictions arise. In addition, any characteristics in the embodiment described above and below can be omitted unless explicitly stated as being essential. Furthermore, the above embodiments may be changed as follows.

In the above embodiments, a configuration is adopted in which the power supply apparatus 10 includes the second branch path 40, but a configuration may also be adopted in which the second branch path 40 is not provided.

In the above embodiments, a configuration is adopted in which the first cutoff portions 25 function as switch portions, but a configuration may also be adopted in which the first cutoff portions 25 cannot return to the first permitted state after being switched to the first cutoff state. The first cutoff portions 25 may be, for example, mechanical fuses that blow when the temperature exceeds a threshold value temperature, or pyrotechnic circuit breakers (for example, pyrofuses) that physically cut the first branch paths 20 as a result of a cutoff signal being input. The same applies to the second cutoff portion 45.

In the above embodiments, a configuration is adopted in which a switch portion is formed by each first cutoff portion 25, but a configuration may also be adopted in which a switch portion is provided separately from the first cutoff portion 25. In this case, for example, a configuration may be adopted in which the first cutoff portion 25 and the switch portions are provided in series between the first upstream conductor 21 and the first downstream conductor 22. In the above embodiment, the second switch portion is constituted by the second cutoff portion 45, but a configuration may also be adopted in which the second switch portion is provided separately from the second cutoff portion 45. In this case, for example, a configuration may be adopted in which the second cutoff portion 45 and the second switch portion are provided in series between the second upstream conductor 41 and the second downstream conductor 42.

In the above embodiments, a configuration is adopted in which the two first branch paths 20 can be electrically connected to each other by the conductive member 80, but a configuration may also be adopted in which three or more first branch paths 20 can be electrically connected to each other by the conductive member 80.

The configuration of the determination unit 251 is not limited to the above configuration in the second embodiment. The determination unit 251 may be a determination circuit configured separately from the control unit 50, for example.

Note that the embodiments disclosed herein are exemplary in all respects and should not be considered as limiting. The scope of the present invention is not limited to the embodiments disclosed herein, and is intended to include all modifications that are within the scope indicated by the claims or the scope that is equivalent to the scope indicated by the claims.

### LIST OF REFERENCE NUMERALS

10 Power supply apparatus
10A Apparatus body
11 Case
12 Common path
20 First branch path (branch path)
21 First upstream conductor (upstream conductor)
22 First downstream conductor (downstream conductor)
22A Parallel downstream conductor
22B Parallel downstream conductor
23 First load-side connection portion (load-side connection portion)
24 First insertion hole
24A First insertion hole (insertion hole)
24B First insertion hole
25 First cutoff portion (cutoff portion)
26 Connection portion
30 Base material
31 Insulation layer
32 First current detection unit
40 Second branch path
41 Second upstream conductor
42 Second downstream conductor
43 Second load-side connection portion
44 Second insertion hole
45 Second cutoff portion
50 Control unit
52 Second current detection unit
80 Conductive member
90 Power source unit
91 Load
92 First load (load)
93 Second load
210 Power supply apparatus
210A Apparatus body
250 Control unit
251 Determination unit
310 Power supply apparatus
350 Control unit
360 First signal line
361 Selector switch portion
362 Second signal line

1. An on-board power supply apparatus comprising:
a common path configured to be supplied with power based on a power source unit;
a plurality of branch paths branching from the common path; and
cutoff portions provided on the respective branch paths,
wherein the branch paths each include an upstream conductor and a downstream conductor provided on an opposite side to the common path side relative to the upstream conductor,
each of the cutoff portions is provided between the upstream conductor and the downstream conductor, and is switched from a permitted state where a flow of a current from the upstream conductor side to the downstream conductor side is permitted to a cutoff state where the flow of the current is cut off, when a cutoff condition is met,
the plurality of downstream conductors are configured to be electrically connectable to each other via a conductive member, and
the downstream conductors are respectively provided with connection portions that are connectable to the conductive member.

2. The on-board power supply apparatus according to claim 1, further comprising
a control unit configured to control the cutoff portions,
wherein the control unit is capable of selectively executing first control and second control,
the first control is control for determining whether or not an individual cutoff condition that is the cutoff condition is met, for each of the branch paths based on a value of a current flowing through the branch path, and switching, to the cutoff state, the cutoff portion provided on the branch path for which it is determined that the individual cutoff condition is met, and
the second control is control for determining whether or not a collective cutoff condition that is the cutoff condition is met, based on a value of a current flowing through at least one of the branch paths, and switching the cutoff portions provided on the plurality of branch paths, to the cutoff state if it is determined that the collective cutoff condition is met.

3. The on-board power supply apparatus according to claim 2,
wherein, when a signal instructing which of the first control and the second control is to be executed is given from outside, the control unit executes the control instructed by the signal.

4. The on-board power supply apparatus according to claim 2, further comprising
a determination unit configured to determine whether or not the plurality of downstream conductors are in a conductive state of being electrically connected to each other by the conductive member,
wherein the control unit executes the first control if the determination unit determines that the plurality of downstream conductors are not in the conductive state, and executes the second control if the determination unit determines that the plurality of downstream conductors are in the conductive state.

5. The on-board power supply apparatus according to claim 4,
wherein, on each of the branch paths, a switch portion is provided between the upstream conductor and the downstream conductor, and
when a determination start condition is met, then, in a state where control is performed so as to bring, into an on-state, the switch portions provided on some branch paths among the plurality of branch paths, and control is performed so as to bring the switch portion provided on another branch path into an off-state, the determination unit obtains a value of a current flowing through at least one branch path among the branch paths in the on-state, and determines whether or not the downstream conductors are in the conductive state based on the obtained value of the current.

6. The on-board power supply apparatus according to claim 2,
wherein the individual cutoff condition is a condition that is met when the value of the current flowing through the branch path exceeds a first threshold value, and
the collective cutoff condition is a condition that is met when a value obtained by multiplying a value of a current flowing through one branch path by a predetermined multiplier exceeds a second threshold value that is larger than the first threshold value.

7. The on-board power supply apparatus according to claim 1,
wherein at least one electronic component that includes the cutoff portion is provided between the upstream conductor and the downstream conductor,
a load-side connection portion for connection to a load is provided on the downstream conductor, and
the connection portion is disposed between the at least one electronic component and the load-side connection portion, closer to the load-side connection portion side.

8. The on-board power supply apparatus according to claim 1,
wherein the plurality of downstream conductors include two parallel downstream conductors aligned parallel to each other,
the connection portion is provided on a surface on one side in an orthogonal direction of each of the parallel downstream conductors, the orthogonal direction being a direction that is orthogonal to a direction in which the two parallel downstream conductors extend and is orthogonal to a direction in which the two parallel downstream conductors are aligned, and
the connection portions provided on the respective parallel downstream conductors face each other in the direction in which the two parallel downstream conductors are aligned.

9. The on-board power supply apparatus according to claim 1,
wherein the cutoff portions provided on the respective branch paths are formed by elements of the same model number.

10. A manufacturing method of an on-board power supply apparatus, comprising:
a preparing step of preparing an apparatus body that includes: a common path configured to be supplied with power based on a power source unit; a plurality of branch paths branching from the common path; and cutoff portions provided on the respective branch paths;
the branch paths each including an upstream conductor and a downstream conductor provided on an opposite side to the common path side relative to the upstream conductor, and
each of the cutoff portions being provided between the upstream conductor and the downstream conductor, and being switched from a permitted state where a flow of a current from the upstream conductor side to the downstream conductor side is permitted to a cutoff state where the flow of the current is cut off, when a cutoff condition is met; and
a selecting step of selecting whether or not to connect the downstream conductors on the plurality of branch paths to each other by a conductive member,
wherein a selection result in the selecting step is applied to the apparatus body to configure the on-board power supply apparatus.
